(19) United States
(12) Patent Application Publication
(10) Pub. No.: US 2024/0347964 A1
(43) Pub. Date: Oct. 17, 2024

(54) CONNECTOR

(71) Applicant: Yazaki Corporation, Tokyo (JP)

(72) Inventors: Seiji Kozono, Shizuoka (JP); Yoshitaka Tsushima, Shizuoka (JP); Masaya Okamoto, Shizuoka (JP); Takenori Ohmura, Shizuoka (JP); Tomoki Matsukawa, Shizuoka (JP)

(21) Appl. No.: 18/748,517

(22) Filed: Jun. 20, 2024

Related U.S. Application Data
(63) Continuation of application No. PCT/JP2023/005610, filed on Feb. 16, 2023.

(30) Foreign Application Priority Data
Feb. 28, 2022 (JP) 2022-029803

(51) Int. Cl. H01R 13/52

(52) U.S. Cl. CPC H01R 13/5213; H01R 13/521

(57) ABSTRACT

A connector includes a housing, a packing that seals an opening portion, and a cover configured to, while holding the packing, move between a closed position where the packing is pressed into contact with the opening portion and an open position where the packing is separated from the opening portion. The packing includes a lid-shaped portion that closes the opening portion when the cover is at the closed position, and a support portion that supports the lid-shaped portion so as to define a space between the lid-shaped portion and the cover when the cover is at the open position. The packing is configured such that as the cover moves from the open position to the closed position, the lid-shaped portion comes into contact with the opening portion and is displaced toward the space, and the support portion is elastically deformed as the lid-shaped portion is displaced.

### CROSS-REFERENCE TO RELATED APPLICATIONS

This is a continuation of International Application No. PCT/JP2023/005610 filed on Feb. 16, 2023, and claims priority from Japanese Patent Application No. 2022-029803 filed on Feb. 28, 2022, the entire content of which is incorporated herein by reference.

### TECHNICAL FIELD

The present invention relates to a connector including a housing including an accommodating chamber capable of accommodating a terminal, a packing for sealing an opening portion of the accommodating chamber, and a cover movable so as to open and close the opening portion of the accommodating chamber while holding the packing.

### BACKGROUND ART

In the related art, a power supply mounted on an automatic vehicle or the like and an electric wire for electrically connecting various electric components may be connected via a connector. The connection is usually performed using a male connector and a female connector. For example, one of connectors in the related art is used in a charging inlet device, which is mounted on an electric automobile or the like, for performing battery charging, and an opening portion of a housing is sealed with a cover when not in use for a purpose of dustproof, terminal protection, prevention of electric shock to the surroundings, or the like (for example, see Patent Literature 1). The cover is attached to the housing in a hinge shape, and is rotatable between a closed position where the cover is in close contact with the opening portion of the housing to close the opening portion and an open position where the cover is separated from the opening portion to open the opening portion.

### CITATION LIST

### Patent Literature

Patent Literature 1: JP2014-032901A

### SUMMARY OF INVENTION

### Technical Problem

In the above-described connector in the related art, a rubber sheet (that is, a packing) in close contact with the wall face of the cover is attached to the cover, and when the cover is at the closed position, the cover is engaged with the housing in a state where the sheet is pressed against the opening portion of the housing, thereby enhancing performance of sealing the opening portion of the housing. Here, depending on the degree of a shape variation caused by manufacturing tolerance of the housing, the cover, and the sheet and a temperature of a surrounding environment when the connector is used, there is a possibility that a large force is required for the operation of engaging the cover with the housing while sandwiching the sheet between the housing and the cover. On the other hand, in order to reduce the force required for the work, for example, if the elastic modulus of a rubber material constituting the sheet is excessively reduced, original sealing performance expected for the sheet may be impaired. Thus, it is generally difficult to achieve appropriate sealing performance and to improve the workability of sealing work.

An object of the present invention is to provide a connector capable of properly exhibiting sealing performance by packings and improving workability of sealing work.

### Solution to Problem

In one aspect of the present invention, a connector includes:
a housing including an accommodating chamber that is configured to accommodate a terminal and having an opening portion that is configured to open to receive a counterpart terminal;
a packing configured to seal the opening portion by closing the opening portion; and
a cover configured to, while holding the packing, move between a closed position where the packing is pressed into contact with the opening portion and an open position where the packing is separated from the opening portion, in which
the packing
   includes a lid-shaped portion that closes the opening portion when the cover is at the closed position, and a support portion that supports the lid-shaped portion so as to define a space between the lid-shaped portion and the cover when the cover is at the open position, and
   is configured such that as the cover moves from the open position to the closed position, the lid-shaped portion comes into contact with the opening portion and is displaced toward the space, and the support portion is elastically deformed as the lid-shaped portion is displaced.

### BRIEF DESCRIPTION OF DRAWINGS

FIG. 1 is a perspective view showing a connector and a counterpart connector according to a first embodiment of the present invention.

FIG. 2 is an exploded perspective view of the connector shown in FIG. 1.

FIG. 3 is a perspective view from a rear side of a cover shown in FIG. 2.

FIG. 4 is a perspective view showing a state in which packings are removed from the cover shown in FIG. 3.

FIG. 5 is a view corresponding to an A-A cross section of FIG. 1, showing a positional relationship between the packing shown in FIG. 4 and an opening portion of a terminal accommodating chamber when the cover is at an open position.

FIG. 6 is a view corresponding to FIG. 5 in which the packing shown in FIG. 4 starts to come into contact with the opening portion of the terminal accommodating chamber in the middle of the cover from the open position to a closed position.

FIG. 7 is a view corresponding to FIG. 5 when the cover is at the closed position.

FIG. 8 is a perspective view showing a packing used in a connector according to a second embodiment of the present invention.

FIG. 9 is a view corresponding to FIG. 5 when the packing shown in FIG. 8 is used.

FIG. 10 is a view corresponding to FIG. 7 when the packing shown in FIG. 8 is used.

FIG. 11 is a perspective view showing a packing used in a connector according to a third embodiment of the present invention.

FIG. 12 is a view corresponding to FIG. 5 when the packing shown in FIG. 11 is used.

FIG. 13 is a view corresponding to FIG. 6 when the packing shown in FIG. 11 is used.

FIG. 14 is a view corresponding to FIG. 7 when the packing shown in FIG. 11 is used.

FIG. 15 is a perspective view showing a packing used in a connector according to a fourth embodiment of the present invention.

FIG. 16 is a view corresponding to FIG. 5 when the packing shown in FIG. 15 is used.

FIG. 17 is a view corresponding to FIG. 7 when the packing shown in FIG. 15 is used.

FIG. 18 is a perspective view showing a packing used in a connector according to a fifth embodiment of the present invention.

FIG. 19 is a view corresponding to FIG. 5 when the packing shown in FIG. 18 is used.

FIG. 20 is a view corresponding to FIG. 7 when the packing shown in FIG. 18 is used.

### DESCRIPTION OF EMBODIMENTS

### First Embodiment

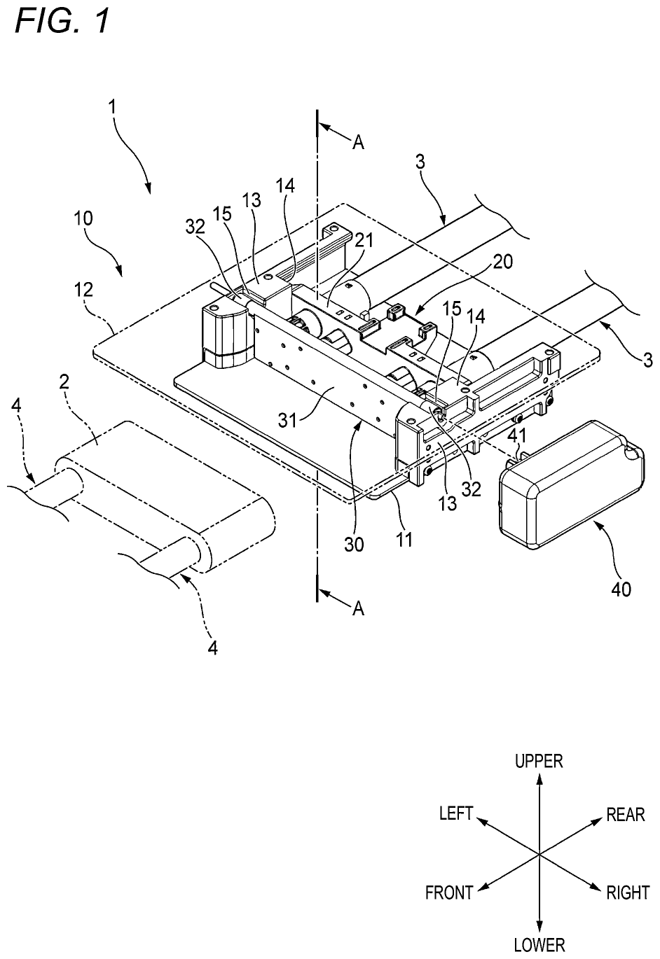

A connector 1 according to a first embodiment of the present invention shown in FIG. 1 will be described below with reference to the drawings. The connector 1 is typically a charging inlet device that is mounted on an electric vehicle or the like and performs battery charging. The connector 1 can be fitted to a counterpart connector 2 (see FIG. 1, typically, an inlet plug). By fitting the connector 1 and the counterpart connector 2 to each other, a pair of electric wires 3 (see FIG. 1) connected to a terminal (not shown) accommodated in a housing 20 (see FIG. 1) of the connector 1 and a pair of electric wires 4 (see FIG. 1) connected to a counterpart terminal (not shown) accommodated in the counterpart connector 2 are electrically connected to each other.

Hereinafter, for convenience of description, as shown in FIG. 1 or the like, “front”, “rear”, “left”, “right”, “upper”, and “lower” are defined. A “front-rear direction”, a “left-right direction”, and an “upper-lower direction” are orthogonal to one another. The front-rear direction coincides with a fitting direction of the connector 1 and the counterpart connector 2. Note that these directions are defined for convenience of description, and do not necessarily correspond to the front-rear direction, the left-right direction, and the upper-lower direction of a vehicle when the connector 1 is mounted on the vehicle.

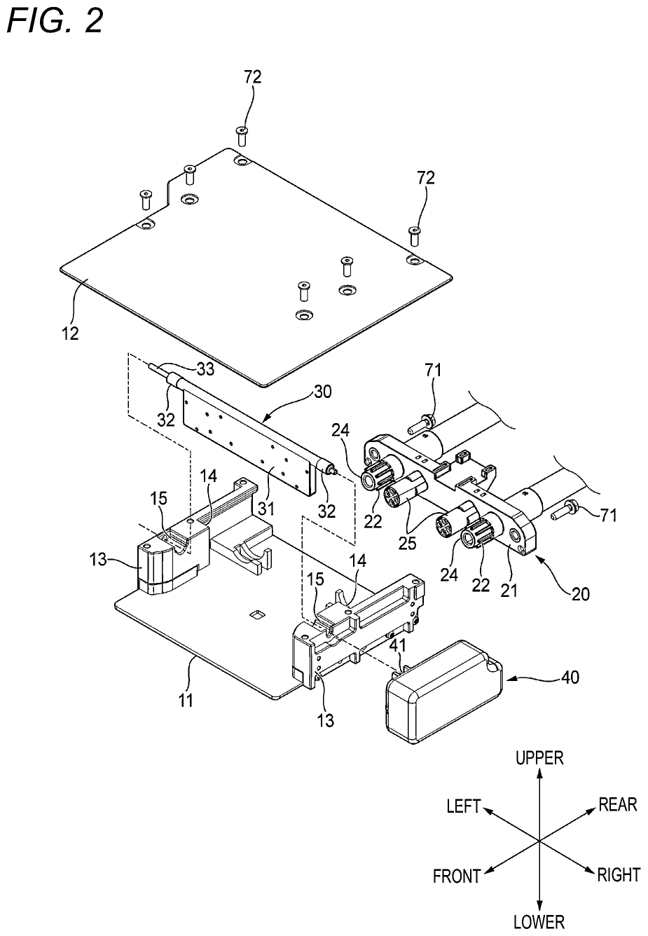

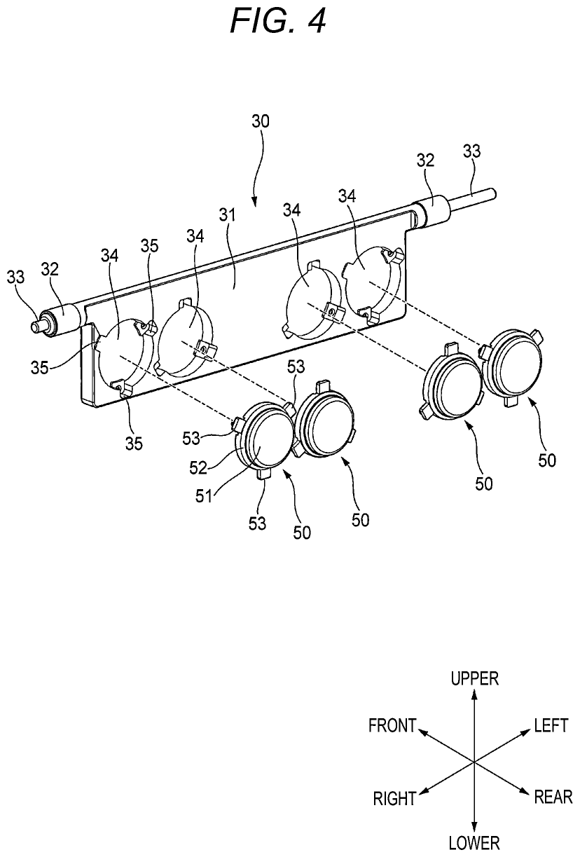

As shown in FIGS. 1 and 2, the connector 1 includes an outer case 10, the housing 20 accommodated in the outer case 10, a cover 30 rotatably supported by the outer case 10, an actuator 40 attached to the outer case 10 and rotationally driving the cover 30, and packings 50 (see FIG. 4) held by the cover 30. Hereinafter, components constituting the connector 1 will be described in order.

First, the outer case 10 will be described. The outer case 10 is a resin-made housing constituting most of an external appearance of the connector 1. As shown in FIGS. 1 and 2, the outer case 10 includes a bottom plate 11 having a rectangular flat plate shape, a top plate 12 having a substantially rectangular flat plate shape and located above the bottom plate 11, and a pair of left and right support walls 13 fixed to a pair of left and right side edges of the bottom plate 11 and the top plate 12 and extending in the front-rear direction. The outer case 10 has a substantially rectangular tube shape that penetrates in the front-rear direction.

As shown in FIG. 2, a pair of fixing faces (planes) 14 facing rearward are formed on inner side faces of the pair of support walls 13 in the left-right direction and facing each other in the left-right direction, at substantially the center in the front-rear direction. The pair of fixing faces 14 function as portions for fixing left and right end portions of a housing body 21 (see FIG. 2) to be described later of the housing 20 (see FIG. 1).

As shown in FIG. 2, a pair of holding portions 15 recessed downward and extending in the left-right direction are formed at positions on upper faces of the pair of support walls 13 in front of the fixing faces 14. The pair of holding portions 15 function as portions that rotatably support a pair of shaft-shaped portions 32 (rotating shafts 33) to be described later of the cover 30 (see FIG. 1).

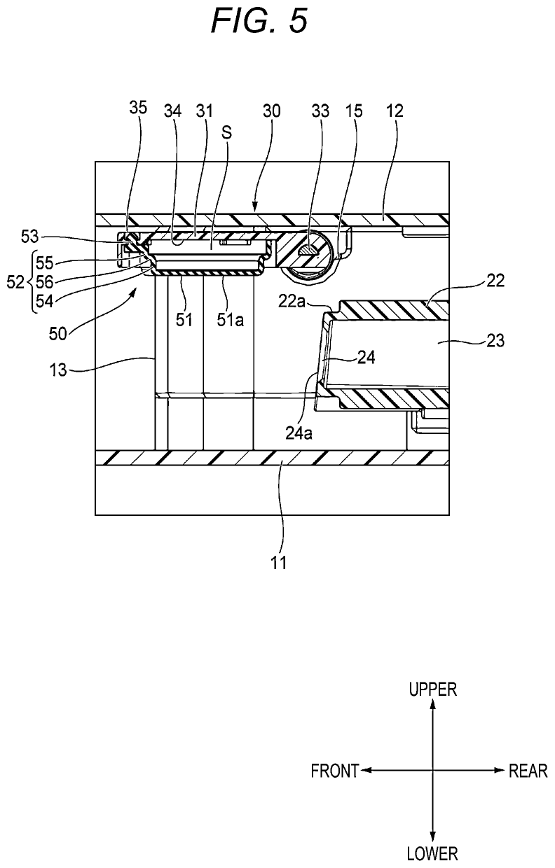

Next, the housing 20 will be described. As shown in FIG. 2, the rein-made housing 20 includes a housing body 21 having an elongated flat plate shape elongated in the left-right direction. The housing body 21 is integrally provided with a pair of cylindrical terminal accommodating tube portions 22 projecting in the front-rear direction from both end portions thereof in the left-right direction. A terminal accommodating chamber 23 penetrating in the front-rear direction is formed inside the terminal accommodating tube portion 22 (see FIG. 5 or the like). A terminal (female terminal, not shown) connected to an end portion of the electric wire 3 (see FIG. 1) is inserted into and fixed to the terminal accommodating chamber 23 from the rear.

As shown in FIG. 5, a tube end portion 22a having a smaller diameter than the other portion of the terminal accommodating tube portion 22 is provided at a front end portion of the terminal accommodating tube portion 22. An opening portion 24, which is a front end opening of the terminal accommodating chamber 23, is formed in the tube end portion 22a. When the connector 1 and the counterpart connector 2 are fitted to each other, the counterpart terminal (male terminal) accommodated in the counterpart connector 2 is inserted into the terminal accommodating chamber 23 via the opening portion 24 and connected to the terminal (female terminal) located in the terminal accommodating chamber 23. In this embodiment, the opening face 24a (annular plane, see FIG. 5) of the opening portion 24 is slightly inclined from a direction perpendicular to the front-rear direction in a direction that moves rearward as it goes upward. The function and effect of the opening face 24a inclined in this manner will be described later.

The housing body 21 is integrally provided with a pair of cylindrical projecting portions 25 that project forward from the housing body 21 at intervals in the left-right direction at positions on the inner side in the left-right direction with respect to the pair of terminal accommodating tube portions 22. Front-rear direction positions of front ends of the pair of terminal accommodating tube portions 22 coincide with front-rear direction positions of front ends of the pair of projecting portions 25. A plurality of terminal accommodating chambers (four in this embodiment) are formed inside the projecting portion 25, and a plurality of opening portions (four in this embodiment) corresponding to the respective terminal accommodating chambers are formed in a front end portion of the projecting portion 25. Similarly to the terminal accommodating chambers 23 of the terminal accommodating tube portion 22, terminals connected to the respective end portions of electric wires (not shown) are inserted and fixed in the terminal accommodating chambers of the projecting portions 25 from the rear.

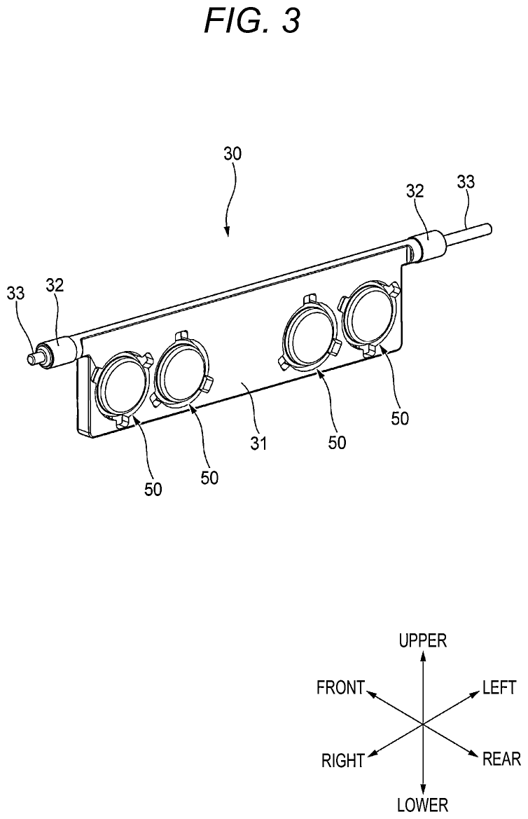

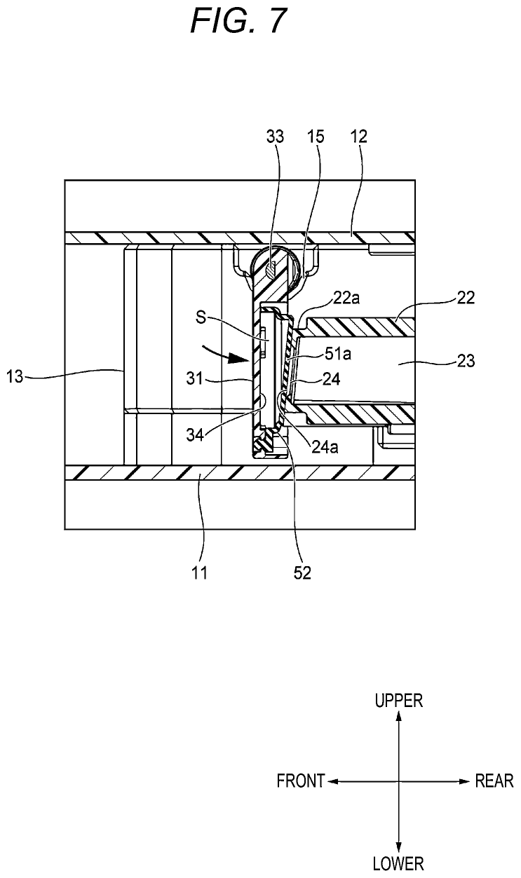

Next, the cover 30 will be described. The cover 30 is a component supported by the outer case 10 and rotatable together with the packings 50, when the packings 50 are held (see FIGS. 3 and 4), between a closed position (see FIG. 7) where the packings 50 are pressed into contact with the opening portion 24 and an open position (see FIG. 5) where the packings 50 are separated from the opening portion 24.

As shown in FIG. 4, the cover 30 includes a resin-made cover body 31 having a substantially rectangular flat plate shape and elongated in the left-right direction. An upper edge portion of the cover body 31 (at a closed position of the cover 30) is integrally provided with a pair of resin-made shaft-shaped portions 32 projecting in both the left and right directions (see FIG. 4). A rod-shaped metal rotating shaft 33 extending in the left-right direction is integrated with the cover 30 by insert molding so as to continuously pass through the upper edge portion of the cover body 31 and the pair of shaft-shaped portions 32 in the left-right direction. The closed position of the cover 30 corresponds to a direction of the cover 30 in which the cover body 31 extends downward parallelly from the rotating shaft 33 (see FIG. 7), and the open position of the cover 30 corresponds to a direction of the cover 30 in which the cover body 31 extends forward parallelly from the rotating shaft 33 (see FIG. 5).

Four circular recessed portions 34, which correspond to the pair of terminal accommodating tube portions 22 and the pair of projecting portions 25 (that is, the four cylindrical projecting portions aligned in the left-right direction) of the housing 20 and are aligned in the left-right direction, are formed in a rear end face (see FIG. 4) of the cover body 31 (at the closed position of the cover 30). The recessed portion 34 functions as a portion that holds the packing 50. Engaged portions 35 projecting outward in a radial direction of the recessed portion 34 are formed at three positions in a circumferential direction of an outer peripheral edge of the recessed portion 34. The engaged portion 35 is engaged with an engaging portion 53 to be described later of the packing 50.

Next, the packing 50 will be described. When the cover 30 is at the closed position, the packing 50 has a function of closing the opening portion 24 of the terminal accommodating tube portion 22 of the housing 20 and a tip end face of the projecting portions 25 in order to implement dustproof, terminal protection, prevention of electric shock to the surroundings, or the like. As shown in FIGS. 4 and 5, the packing 50 integrally includes a disk-shaped lid-shaped portion 51 and a substantially cylindrical support portion 52 extending forward from an outer peripheral edge of the lid-shaped portion 51 (at the closed position of the cover 30). On an outer peripheral face of the support portion 52, engaging portions 53 that project outward in a radial direction of the support portion 52 are formed at three positions in the circumferential direction corresponding to the three engaged portions 35 of the recessed portion 34.

A rear end face of the lid-shaped portion 51 (at the closed position of the cover 30) functions as a sealing face 51a (see FIGS. 5 to 7) that closes the opening portion 24 of the tube end portion 22a of the terminal accommodating tube portion 22. An outer diameter of the lid-shaped portion 51 is larger than an outer diameter of the tube end portion 22a of the terminal accommodating tube portion 22.

As shown in FIG. 5, the support portion 52 has a stepped cylindrical shape having a small-diameter portion 54 connected to the outer peripheral edge of the lid-shaped portion 51, a large-diameter portion 55 located in front of the small-diameter portion 54 (at the closed position of the cover 30) and having a larger diameter than the small-diameter portion 54, and a connecting portion 56 connecting the small-diameter portion 54 to the large-diameter portion 55.

As shown in FIGS. 3 to 5, the packing 50 is accommodated and held in the recessed portion 34 such that an opening end of the support portion 52 (the large-diameter portion 55) abuts on a bottom face of the recessed portion 34 and the engaging portions 53 of the packing 50 are engaged with the engaged portions 35 of the recessed portion 34. In a state in which the packing 50 is held by the recessed portion 34 (the cover 30) (the non-elastically deformed state of the packing 50), as shown in FIG. 5, the opening end of the support portion 52 (the large-diameter portion 55) is covered with a side wall (that is, the cover 30) of the recessed portion 34, and a space S is defined between the lid-shaped portion 51 and the bottom face of the recessed portion 34 (that is, the cover 30). The packing 50 is prevented from being separated from the recessed portion 34 by the engagement between the engaging portions 53 of the packing 50 and the engaged portions 35 of the recessed portion 34. The components constituting the connector 1 have been described above.

Next, a procedure for assembling the connector 1 will be described. First, as shown in FIG. 2, a pair of support walls 13 are screwed to a pair of left and right side edges of an upper face of the bottom plate 11 by screws (not shown). Next, the housing 20 for accommodating a pair of terminals (not shown) connected to end portions of the pair of electric wires 3 (see FIG. 1) is fixed to the pair of support walls 13 at a position between the pair of support walls 13. Specifically, front end faces of both end portions of the housing body 21 in the left-right direction are screwed to the fixing faces 14 of the pair of support walls 13 by a pair of screws 71 (see FIG. 2).

Next, the cover 30 holding the four packings 50 is rotatably supported by the pair of support walls 13. Specifically, the pair of shaft-shaped portions 32 (rotating shafts 33) of the cover 30 are accommodated in the holding portions 15 of the pair of support walls 13 and rotatably supported. Accordingly, as shown in FIGS. 5 to 7, in a state where the rotating shaft 33 of the cover 30 is located above the opening portions 24 of the tube end portions 22a of the terminal accommodating tube portions 22 of the housing 20, the cover 30 is in a state capable of rotating together with the packings 50 between the closed position (see FIG. 7) and the open position (see FIG. 5).

Next, the top plate 12 is screwed to the upper faces of the pair of support walls 13 by a plurality of screws 72 (see FIG. 2). Accordingly, the outer case 10 having a substantially rectangular tube shape penetrating in the front-rear direction is completed (see FIG. 1). The housing 20 is accommodated in an inner space of the completed outer case 10, and the cover 30 is rotatably accommodated therein.

Next, as shown in FIG. 1, the actuator 40 is attached to the outer case 10. The actuator 40 is typically an electric motor including a drive shaft 41 (see FIG. 1). Specifically, the actuator 40 is attached to an outer side face of the right support wall 13 such that the drive shaft 41 is connected to a right end of the rotating shaft 33 of the cover 30 so as to be integrally rotatable therewith. Accordingly, by electrically controlling the actuator 40, the cover 30 can be rotatably driven between the closed position (see FIG. 7) and the open position (see FIG. 5). As described above, the assembly of the connector 1 is completed.

When the connector 1 and the counterpart connector 2 are not fitted to each other, the cover 30 is maintained at the closed position (see FIG. 7). Accordingly, the sealing faces 51a of the lid-shaped portions 51 of the four packings 50 close the opening faces 24a of the opening portions 24 of the pair of terminal accommodating tube portions 22 of the housing 20 and the tip end faces of the pair of projecting portions 25, thereby achieving dustproof, terminal protection, prevention of electric shock to the surroundings, or the like. On the other hand, when the connector 1 and the counterpart connector 2 are fitted to each other, the cover 30 is maintained at the open position (see FIG. 5). Accordingly, the pair of opening portions 24 are opened, and the pair of counterpart terminals (male terminals) accommodated in the counterpart connector 2 can be inserted into the terminal accommodating chamber 23 via the opening portion 24.

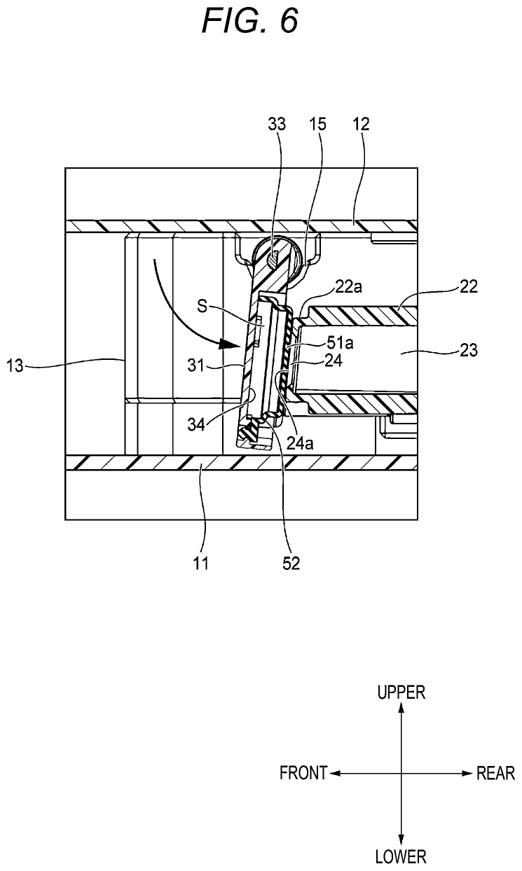

Hereinafter, a sealing work of the opening portion 24 by the packings 50 when the cover 30 is moved from the open position to the closed position will be described in detail with reference to FIGS. 5 to 7. In the process of moving the cover 30 from the open position (see FIG. 5) toward the closed position (FIG. 7), as shown in FIG. 6, the packing 50 starts to come into contact with the opening face 24a of the opening portion 24 at a time point when the cover 30 reaches a position immediately before reaching the closed position, that is, the cover 30 reaches a position slightly inclined from a direction perpendicular to the front-rear direction in a direction in which the cover 30 moves rearward as the cover 30 (cover body 31) moves upward. At this time, due to an inclination direction of the cover 30 (cover body 31) and an inclination direction of the opening face 24a of the opening portion 24 being parallel to each other, the sealing face 51a of the lid-shaped portion 51 of the packing 50 is simultaneously (collectively) in contact with the entire opening face 24a (see FIG. 6). Therefore, deviation of the packing 50 or the like can be suppressed as compared with a case where the sealing face 51a gradually comes into contact with the opening portion 24 in order from a position close to the rotating shaft 33 (upper position) to a position far from the rotating shaft 33 (lower position).

When the rotation of the cover 30 to the closed position progresses from the state shown in FIG. 6, the lid-shaped portion 51 is displaced toward the space S by the pressing from the opening portion 24 as the rotation of the cover 30 progresses, and the support portion 52 is elastically deformed. Accordingly, the lid-shaped portion 51 can be pressed against the opening portion 24 with an appropriate elastic force by elastic deformation of the support portion 52 while maintaining the state in which the opening portion 24 is closed by the lid-shaped portion 51. When the cover 30 reaches the closed position, as shown in FIG. 7, the support portion 52 is elastically deformed, and a state in which the sealing face 51a of the lid-shaped portion 51 is pressed into contact with the opening face 24a is maintained. In this embodiment, due to the inclination of the opening face 24a of the opening portion 24, a degree of elastic deformation of the lower position in the support portion 52 is larger than a degree of elastic deformation of the upper position.

As described above, according to the connector 1 of the first embodiment, when the cover 30 is moved from the open position to the closed position, the packing 50 held by the cover 30 closes and seals the opening portion 24 of the terminal accommodating chamber 23 provided in the housing 20. The packing 50 includes a lid-shaped portion 51 that closes the opening portion 24, and the support portion 52 that supports the lid-shaped portion 51 so as to define the space S between the lid-shaped portion 51 and the cover 30. When the opening portion 24 is sealed with the packing 50, the lid-shaped portion 51 is displaced toward the space S as the cover 30 rotates, and the support portion 52 is elastically deformed. Accordingly, the lid-shaped portion 51 can be pressed against the opening portion 24 with the appropriate elastic force by the elastic deformation of the support portion 52 while maintaining the state in which the opening portion 24 is closed by the lid-shaped portion 51. Accordingly, it is possible to prevent the force required for opening and closing the cover 30 from becoming excessively large even when a shape variation of each member due to the manufacturing tolerance or the like of each member is mainly absorbed by the elastic deformation of the support portion 52 and sealing performance as designed is exhibited. Accordingly, the connector 1 according to the first embodiment can properly exhibit sealing performance by the packing 50 and the improve workability of sealing work by opening and closing the cover.

Further, the opening face 24a of the opening portion 24 of the terminal accommodating chamber 23 has a structure inclined so as to approach the sealing face 51a of the lid-shaped portion 51 in a rotating direction as being separated from the rotating shaft 33 of the cover 30. Accordingly, compared with a case where the cover 30 does not have the inclined structure, the sealing face 51a can be brought into contact with the entire opening portion 24 at once when the cover 30 is closed. Accordingly, it is possible to suppress the deviation of the packing 50 or the like as compared with a case where the sealing face 51a gradually comes into contact with the opening portion 24 in the order from the position close to the rotating shaft 33 to the position far from the rotating shaft 33. As a result, the sealing performance of the packing 50 can be further improved.

In the first embodiment, the opening face 24a of the opening portion 24 of the terminal accommodating chamber 23 has the structure inclined so as to approach the sealing face 51a of the lid-shaped portion 51 in the rotating direction as being separated from the rotating shaft 33 of the cover 30. On the other hand, in a structure in which the sealing face 51a of the lid-shaped portion 51 is inclined so as to approach the opening face 24a in the rotating direction as being separated from the rotating shaft 33, in other words, at the open position of the cover (see FIG. 5), the sealing face 51a of the lid-shaped portion 51 may have a structure slightly inclined from a direction perpendicular to the upper-lower direction so as to move upward toward the rear. Accordingly, as in the case of the first embodiment, when the cover 30 is closed, since the sealing face 51a can be brought into contact with the entire opening portion 24 at once, the same actions and effects as in the first embodiment can be achieved.

In each of the following embodiments, the same parts as those in the first embodiment are denoted by the same reference numerals as in the first embodiment, and the description thereof is omitted. In each of the following embodiments, unlike the first embodiment, the opening face 24a of the opening portion 24 of the tube end portion 22a of the terminal accommodating tube portion 22 of the housing 20 is not inclined (extends perpendicular to the front-rear direction).

### Second Embodiment

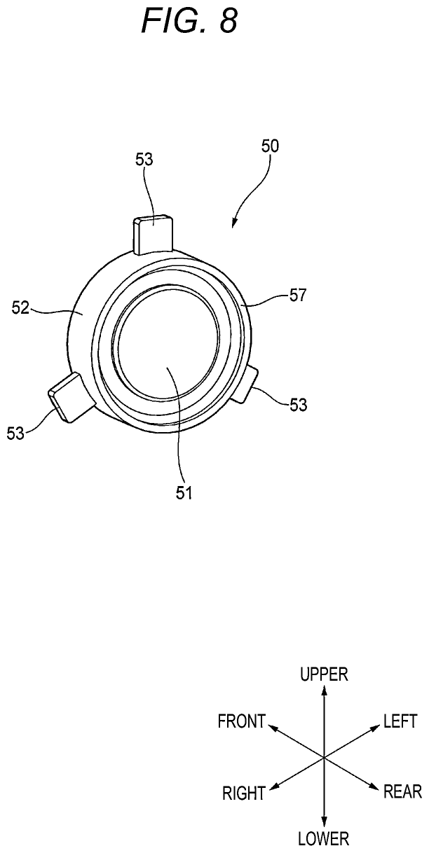

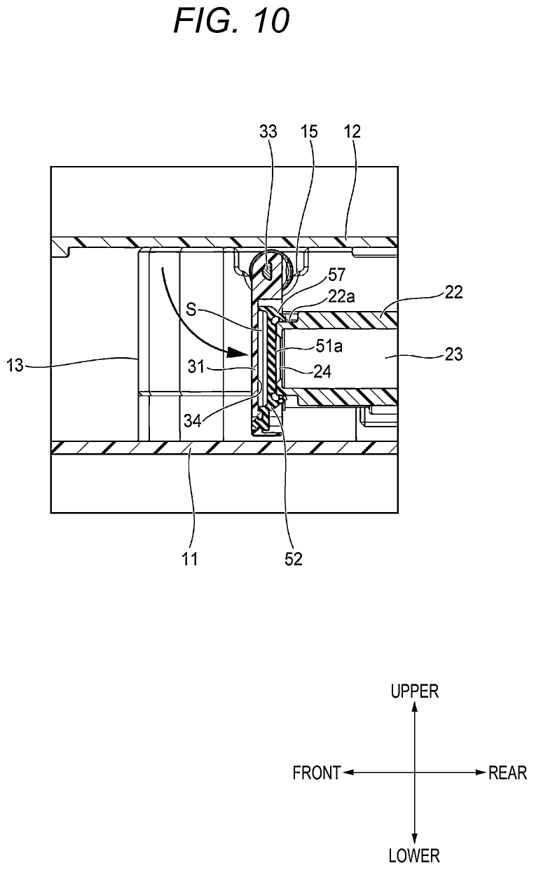

As shown in FIGS. 8 to 10, the packing 50 used in a connector according to a second embodiment of the present invention is different from the packing 50 (see FIGS. 5 to 7) in the first embodiment only in that the cylindrical support portion 52 has a simple cylindrical shape and a cylindrical tubular projecting portion 57 that projects rearward from an outer peripheral edge of the lid-shaped portion 51 (at a closed position of the cover 30). An inner diameter of the tubular projecting portion 57 is larger than an outer diameter of the tube end portion 22a of the terminal accommodating tube portion 22 (see FIG. 10). The tubular projecting portion 57 projects so as to surround the sealing face 51a of the lid-shaped portion 51.

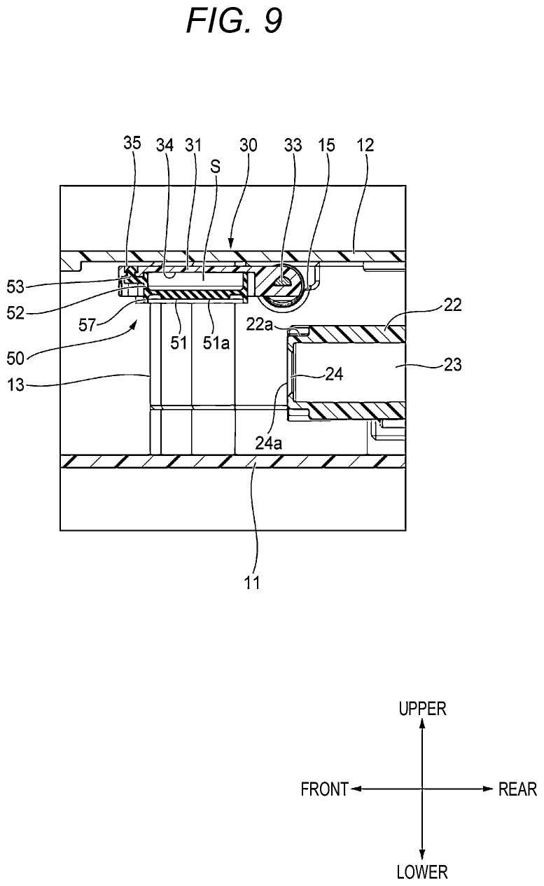

In the packing 50 of this embodiment, in a state in which the cover 30 is rotated from the open position (see FIG. 9) toward the closed position (see FIG. 10) and reaches the closed position (see FIG. 10), as in the first embodiment, the support portion 52 is elastically deformed when the lid-shaped portion 51 is displaced toward the space S by the pressing from the opening portion 24, and the state in which the sealing face 51a of the lid-shaped portion 51 is pressed into contact with the opening face 24a is maintained. Further, as shown in FIG. 10, with the displacement of the lid-shaped portion 51, the tubular projecting portion 57 is displaced to approach the tube end portion 22a of the terminal accommodating tube portion 22 (that is, to be narrowed inward in a radial direction). Accordingly, the approach of water, foreign matter, or the like between the opening portion 24 of the terminal accommodating tube portion 22 and the lid-shaped portion 51 is suppressed by the tubular projecting portion 57 that is displaced as described above. As a result, the sealing performance of the packing 50 can be further improved.

In this embodiment, when the cover 30 is at the closed position, an opening end portion of the tubular projecting portion 57 abuts on an outer peripheral face of the tube end portion 22a of the terminal accommodating tube portion 22. However, in the point that the above-described removal effect of water, foreign matter, or the like is exerted, the opening end portion of the tubular projecting portion 57 does not necessarily abut on the outer peripheral face of the tube end portion 22a of the terminal accommodating tube portion 22. Such an effect can be expected if the opening end portion of the tubular projecting portion 57 is brought close to the outer peripheral face of the tube end portion 22a.

### Third Embodiment

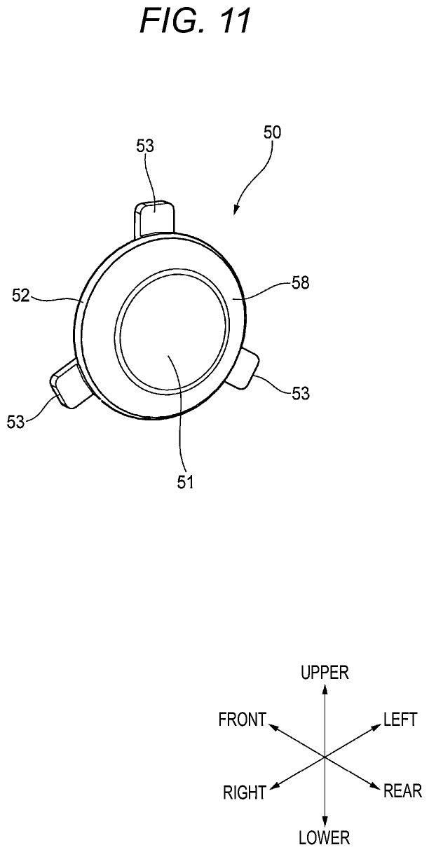

As shown in FIGS. 11 to 14, the packing 50 used in a connector according to a third embodiment of the present invention is different from the packing 50 (see FIGS. 5 to 7) in the first embodiment only in that the tubular support portion 52 has a bent shape including a first portion 58 extending in a direction in which the space S is enlarged as being separated from the lid-shaped portion 51, and a second portion 59 continuous with the first portion 58 and tapered in a direction in which the space S is reduced as being separated from the first portion 58.

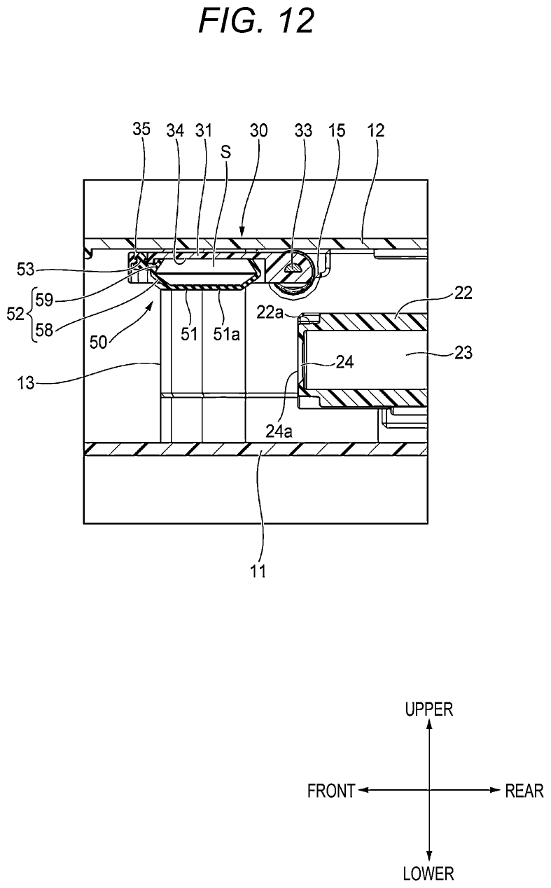

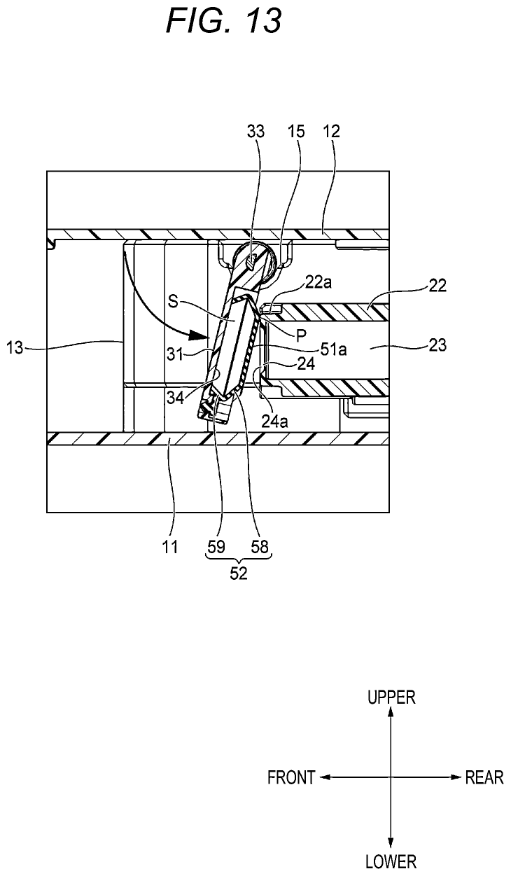

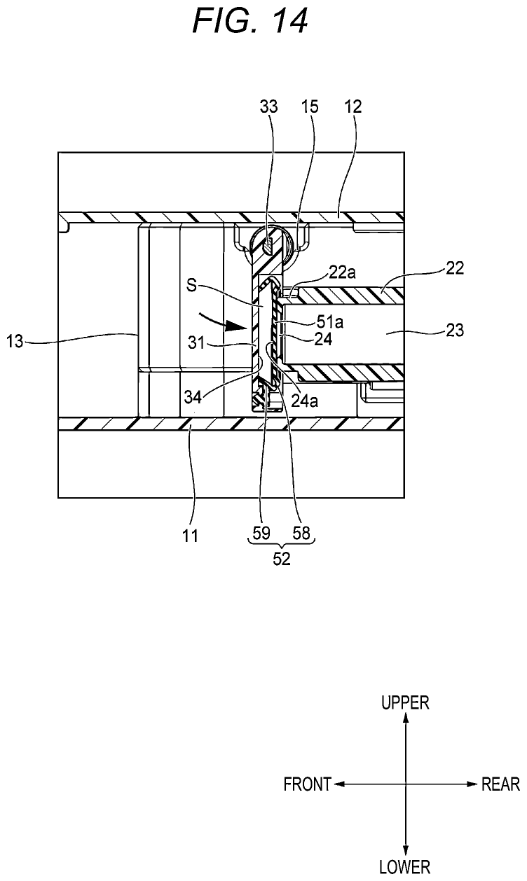

In the packing 50 of this embodiment, in the process of moving the cover 30 from the open position (see FIG. 12) toward the closed position (see FIG. 14), as shown in FIG. 13, at the stage immediately before the cover 30 reaches the closed position, only an upper end position Pin an annular boundary portion between the lid-shaped portion 51 and the first portion 58 comes into contact with the annular opening face 24a (the upper end position of) of the opening portion 24. Accordingly, a deformation mode of the packing 50 in this stage can be easily stabilized.

From the state shown in FIG. 13, in a state in which the cover 30 is rotated toward the closed position (see FIG. 14) and reaches the closed position (see FIG. 14), as in the first embodiment, the support portion 52 is elastically deformed when the lid-shaped portion 51 is displaced toward the space S by the pressing from the opening portion 24, and the state in which the sealing face 51a of the lid-shaped portion 51 is pressed into contact with the opening face 24a is maintained. In this embodiment, since the support portion 52 has the bent shape as described above, the support portion 52 is easily deformed flexibly around a bent portion. Therefore, as shown in FIG. 14, the support portion 52 is deformed such that the first portion 58 is stored in the second portion 59. Accordingly, deviation of the packing 50 or the like when the cover 30 is closed can be suppressed. As a result, the sealing performance of the packing 50 can be further improved.

### Fourth Embodiment

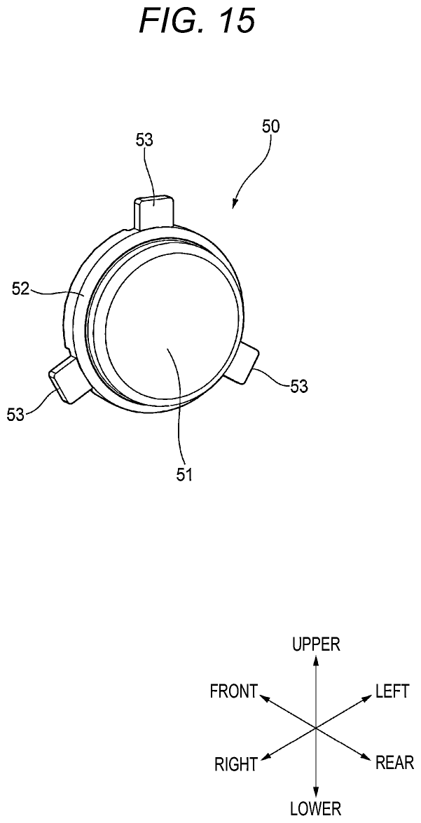

As shown in FIGS. 15 to 17, the packing 50 used in a connector according to a fourth embodiment of the present invention has a similar shape to that of the first embodiment. That is, the tubular support portion 52 has a stepped cylindrical shape having a small-diameter portion 54, a large-diameter portion 55 located in front of the small-diameter portion 54 (at a closed position of the cover 30) and having a larger diameter than the small-diameter portion 54, and a connecting portion 56 connecting the small-diameter portion 54 to the large-diameter portion 55.

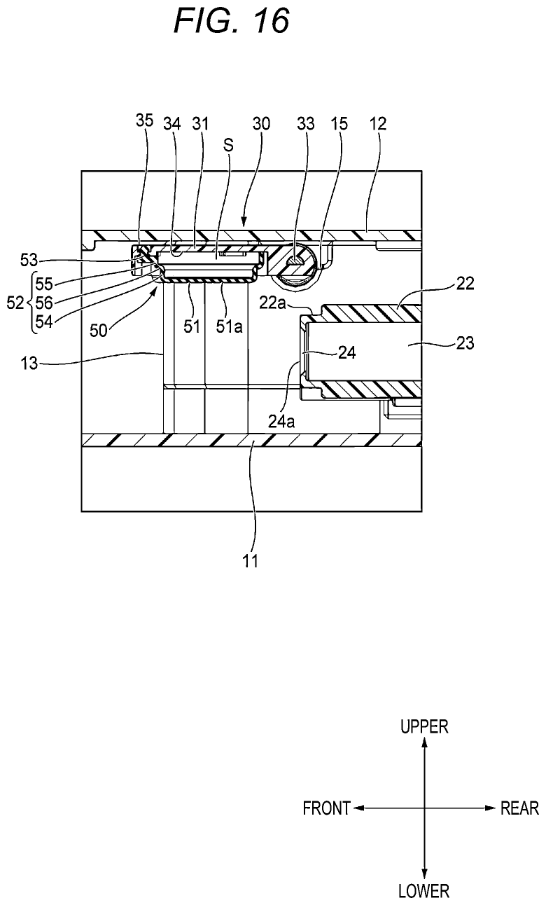

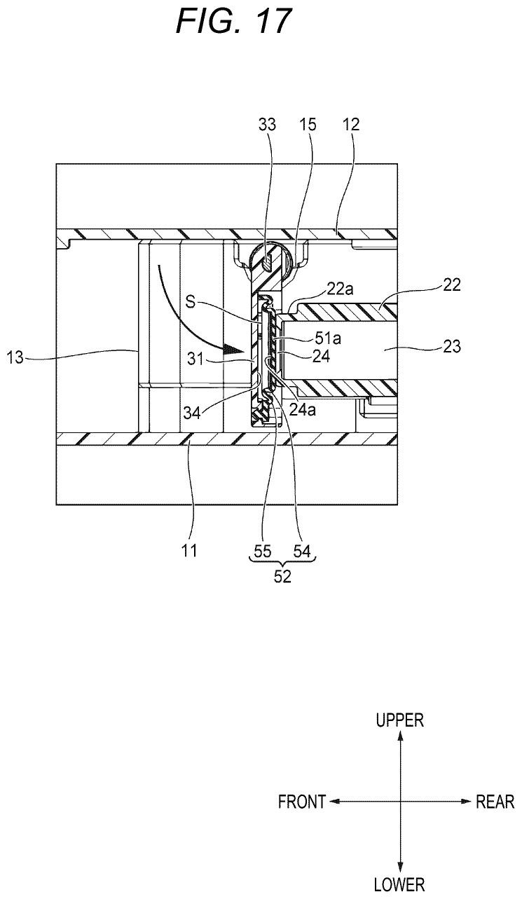

In the packing 50 of this embodiment, in a state in which the cover 30 is rotated from the open position (see FIG. 16) toward a closed position (see FIG. 17) and reaches the closed position (see FIG. 17), as in the first embodiment, the support portion 52 is elastically deformed when the lid-shaped portion 51 is displaced toward the space S by the pressing from the opening portion 24, and the state in which the sealing face 51a of the lid-shaped portion 51 is pressed into contact with the opening face 24a is maintained. Further, as shown in FIG. 17, with the displacement of the lid-shaped portion 51, the lid-shaped portion 51 can be displaced such that the small-diameter portion 54 is stored in the large-diameter portion 55 while mainly deforming the connecting portion 56. Accordingly, appropriate deformation of the support portion 52 can be achieved, and deviation of the packing 50 or the like can be suppressed when the cover 30 is closed. As a result, the sealing performance of the packing 50 can be further improved.

### Fifth Embodiment

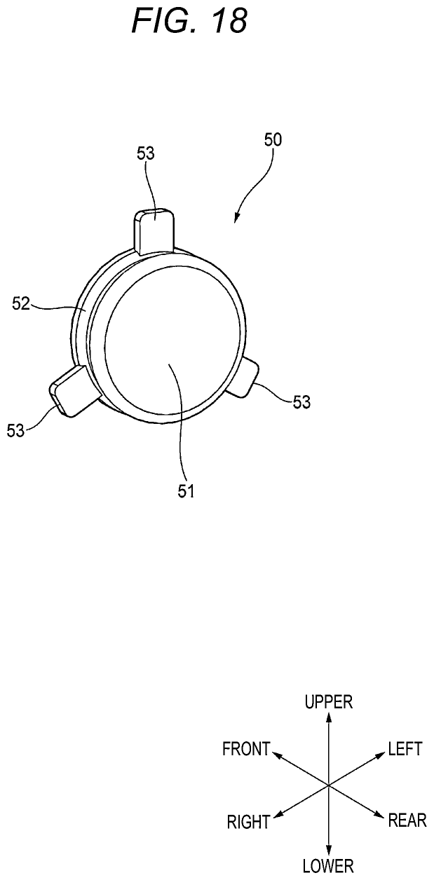

As shown in FIGS. 18 to 20, the packing 50 used in a connector according to a fifth embodiment of the present invention is different from the packing 50 (see FIGS. 5 to 7) in the first embodiment only in that the tubular support portion 52 has a bellows shape in which increase and decrease of a tubular diameter are continuous as the tubular support portion 52 is separated from the lid-shaped portion 51.

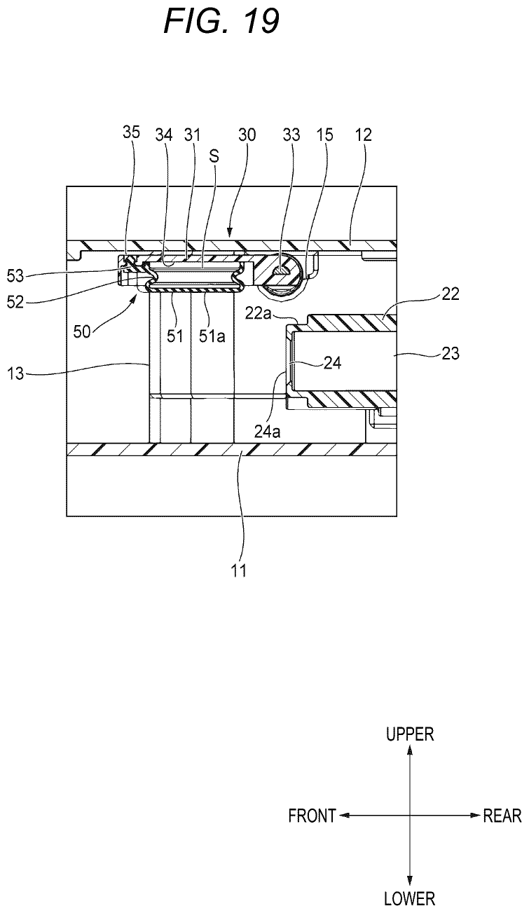

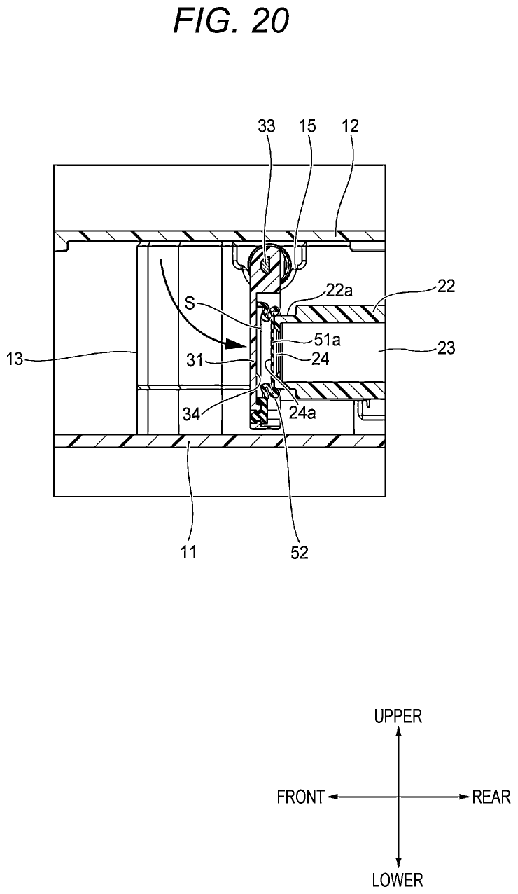

In the packing 50 of this embodiment, in a state in which the cover 30 is rotated from the open position (see FIG. 19) toward a closed position (see FIG. 20) and reaches the closed position (see FIG. 20), as in the first embodiment, the support portion 52 is elastically deformed when the lid-shaped portion 51 is displaced toward the space S by the pressing from the opening portion 24, and the state in which the sealing face 51a of the lid-shaped portion 51 is pressed into contact with the opening face 24a is maintained. Further, when the lid-shaped portion 51 is displaced so as to enter the tube of the support portion 52, the bellows shape tubular wall portion of the support portion 52 deformed so as to be crushed by the displacement thereof can be disposed to surround the periphery of the opening portion 24 of the tube end portion 22a of the terminal accommodating tube portion 22 (see FIG. 20). Accordingly, it is possible to suppress the approach of water, foreign matter, or the like between the opening portion 24 of the terminal accommodating tube portion 22 and the lid-shaped portion 51 from the bellows shape tubular wall portion of the support portion 52 deformed in such a manner. As a result, the sealing performance of the packing 50 can be further improved.

The present invention is not limited to the embodiments described above and various modifications can be adopted within the scope of the present invention. For example, the present invention is not limited to the embodiments described above, and may be modified or improved as appropriate. In addition, materials, shapes, sizes, numbers, arrangement positions, or the like of components in the embodiments described above are freely selected and are not limited as long as the present invention can be implemented.

Here, in each embodiment of the present invention described above, a connector (1) includes:
a housing (20) including an accommodating chamber (23) that is configured to accommodate a terminal and having an opening portion (24) that is configured to open to receive a counterpart terminal; a packing (50) configured to seal the opening portion (24) by closing the opening portion (24); and a cover (30) configured to, while holding the packing (50), move between a closed position where the packing (50) is pressed into contact with the opening portion (24) and an open position where the packing (50) is separated from the opening portion (24), in which
the packing (50) includes a lid-shaped portion (51) that closes the opening portion (24) when the cover (30) is at the closed position, and a support portion (52) that supports the lid-shaped portion (51) so as to define a space(S) between the lid-shaped portion (51) and the cover (30) when the cover (30) is at the open position, and
the packing (50) is configured such that as the cover (30) moves from the open position to the closed position, the lid-shaped portion (51) comes into contact with the opening portion (24) and is displaced toward the space(S), and the support portion (52) is elastically deformed as the lid-shaped portion (51) is displaced.

According to the connector configured as described above, when the cover is moved from the open position to the closed position, the packing held by the cover closes and seals the opening portion of the accommodating chamber provided in the housing. The packing includes the lid-shaped portion that closes the opening portion, and the support portion that supports the lid-shaped portion so as to define the space between the lid-shaped portion and the cover. When the opening portion is sealed with the packing, the lid-shaped portion is displaced toward the space as the cover moves, and the support portion is elastically deformed according to the displacement. Accordingly, the opening portion can be closed by the lid-shaped portion in a state in which the lid-shaped portion is appropriately pressed against the opening portion by the elastic force generated in the support portion. Further, the shape variation due to the manufacturing tolerance or the like of the housing, the cover, and the packing can be absorbed by the elastic deformation of the support portion. In other words, it is possible to prevent the force required for opening and closing the cover is prevented from becoming excessively large without impairing the sealing performance by the packing. Accordingly, the connector of the present invention can properly exhibit the sealing performance by the packing and improve the workability of the sealing work.

Further, the cover (30) may be movable in a rotating direction together with the packing (50) by rotating around a rotating shaft (33) extending in a direction along an opening face (24a) of the opening portion (24), and
may have at least one structure of a structure in which the opening face (24a) of the opening portion (24) is inclined so as to approach a sealing face (51a) of the lid-shaped portion (51) in the rotating direction as being separated from the rotating shaft (33), and a structure in which the sealing face (51a) of the lid-shaped portion (51) is inclined so as to approach the opening face (24a) in the rotating direction as being separated from the rotating shaft (33). According to the connector having the above configuration, in the case where the opening face of the opening portion of the accommodating chamber has a structure which is inclined so as to approach the sealing face of the lid-shaped portion in the rotating direction as being separated from the rotating shaft of the cover, when the cover is closed, the sealing face of the packing can be brought into contact with the entire opening portion of the accommodating chamber at a timing closer to the same time when the cover is closed, as compared with the case where the opening face does not have the inclined structure. The same applies to a case where the sealing face of the lid-shaped portion has the structure inclined so as to approach the opening face of the accommodating chamber in the rotating direction as being separated from the rotating shaft of the cover. Accordingly, it is possible to suppress the deviation of the packing or the like as compared with the case where the sealing face gradually comes into contact with the opening portion in the order from the portion close to the rotating shaft to the position far from the rotating shaft (that is, the sealing face does not have the inclined structure in the present configuration). As a result, the sealing performance of the packing can be further improved.

Further, the accommodating chamber (23) may have a tube shape having the opening portion (24) at a tube end portion (22a),
the packing (50) may further include a tubular projecting portion (57) having a tubular diameter larger than that of the tube end portion (22a) and projecting so as to surround the lid-shaped portion (51), and
when the cover (30) is at the closed position, the tubular projecting portion (57) may be configured to be displaced so as to approach an outer peripheral face of the tube end portion (22a) as the lid-shaped portion (51) is displaced.

According to the connector having the above configuration, the packing has a tubular projecting portion projecting so as to surround the lid-shaped portion. When the cover is closed, along with the displacement of the lid-shaped portion, the tubular projecting portion is displaced so as to approach the tube end portion of the accommodating chamber (that is, such that the opening end of the tubular projecting portion is narrowed). Accordingly, it is possible to suppress the approach of water, foreign matter, or the like to a position where the opening portion of the accommodating chamber and the lid-shaped portion come into close contact with each other by the tubular projecting portion displaced as described above approaching (preferably abutting on) the outer peripheral face of the tube end portion of the accommodating chamber. As a result, the sealing performance of the packing can be further improved.

Further, the support portion (52) of the packing (50) may have a tube shape extending from the lid-shaped portion (51) toward the cover (30), and may have a bent shape narrowing in a direction in which a tubular diameter decreases after widening in a direction in which the tubular diameter increases as being separated from the lid-shaped portion (51).

According to the connector having the above configuration, the support portion of the packing has the tube shape, and has the bent shape narrowing in the direction in which the tubular diameter decreases after widening in the direction in which the tubular diameter increases as being separated from the lid-shaped portion. Accordingly, as compared with the case where the bent shape is not provided, the support portion is easily deformed flexibly around the bent portion, and it is possible to suppress deviation of the packing or the like when the cover is closed. As a result, the sealing performance of the packing can be further improved.

Further, the support portion (52) of the packing (50) may include a small-diameter portion (54) having a tube shape extending from the lid-shaped portion (51) toward the cover (30) and connected to the lid-shaped portion (51), a large-diameter portion (55) located at a position farther from the lid-shaped portion (51) than the small-diameter portion (54) and having a larger tubular diameter than the small-diameter portion (54), and a connecting portion (56) connecting the small-diameter portion (54) to the large-diameter portion (55).

According to the connector having the above configuration, the support portion of the packing has the tube shape, and the small-diameter portion and the large-diameter portion are connected by the connecting portion. Accordingly, when the cover is closed, the support portion can be deformed such that the small-diameter portion is stored in the large-diameter portion while mainly deforming the connecting portion. Accordingly, proper elastic deformation of the support portion can be achieved, and deviation of the packing or the like can be suppressed when the cover is closed. As a result, the sealing performance of the packing can be further improved.

Further, the support portion (52) of the packing (50) may have a tube shape extending from the lid-shaped portion (51) toward the cover (30), and may have a bellows shape in which increase and decrease of a tubular diameter are continuous as the support portion (52) is separated from the lid-shaped portion (51).

According to the connector having the above configuration, the support portion of the packing has the tube shape, and has the bellows shape in which the increase and decrease of the tubular diameter are continuous as the support portion is separated from the lid-shaped portion. Accordingly, when the cover is closed, the lid-shaped portion is displaced so as to enter the tube of the support portion, and the tubular wall portion of the support portion deformed so as to be crushed by the displacement can be disposed so as to surround the periphery of the opening portion of the accommodating portion. Accordingly, it is possible to suppress the approach of water, foreign matter, or the like to the position where the opening portion of the accommodating chamber and the lid-shaped portion come into close contact with each other by the tubular wall portion of the support portion deformed in this manner. As a result, the sealing performance of the packing can be further improved.

Further, the support portion (52) of the packing (50) may have a tube shape extending from the lid-shaped portion (51) toward the cover (30), and an opening end of the support portion (52) may be held by the cover (30) so as to be covered with the cover (30).

According to the connector having the above configuration, the support portion of the packing has the tube shape, and the opening end of the support portion is covered with the cover. Accordingly, as compared with a case where the support portion has a completely hollow structure (for example, a structure like a balloon), by allowing air to enter and exit the space described above through a gap between the cover and the packing, it is possible to suppress the foreign matter or the like from entering the space between the lid-shaped portion and the cover while facilitating the deformation of the support portion.

The present application is based on a Japanese patent application (Japanese Patent Application No. 2022-029803) filed on Feb. 28, 2022, and the contents thereof are incorporated herein by reference.

### INDUSTRIAL APPLICABILITY

The connector of the present invention can properly exhibit sealing performance by packings and improve workability of sealing work. The present invention having this effect can be used, for example, in a charging inlet device that is mounted on an electric vehicle or the like and is for charging a battery.

### REFERENCE SIGNS LIST

1 connector
20 housing
22a tube end portion
23: terminal accommodating chamber (accommodating chamber)
24 opening portion
24a opening face
30 cover
33 rotating shaft
50 packing
51 lid-shaped portion
51a sealing face
52 support portion
54 small-diameter portion
55 large-diameter portion
56 connecting portion
57 tubular projecting portion
S space

1. A connector comprising:
a housing including an accommodating chamber that is configured to accommodate a terminal and having an opening portion that is configured to open to receive a counterpart terminal;
a packing configured to seal the opening portion by closing the opening portion; and
a cover configured to, while holding the packing, move between a closed position where the packing is pressed into contact with the opening portion and an open position where the packing is separated from the opening portion, wherein:
the packing includes a lid-shaped portion that closes the opening portion when the cover is at the closed position, and a support portion that supports the lid-shaped portion so as to define a space between the lid-shaped portion and the cover when the cover is at the open position; and
the packing is configured such that as the cover moves from the open position to the closed position, the lid-shaped portion comes into contact with the opening portion and is displaced toward the space, and the support portion is elastically deformed as the lid-shaped portion is displaced.

2. The connector according to claim 1, wherein:
the cover is movable in a rotating direction together with the packing by rotating around a rotating shaft extending in a direction along an opening face of the opening portion; and
the cover has at least one structure of a structure in which the opening face of the opening portion is inclined so as to approach a sealing face of the lid-shaped portion in the rotating direction as being separated from the rotating shaft, and a structure in which the sealing face of the lid-shaped portion is inclined so as to approach the opening face in the rotating direction as being separated from the rotating shaft.

3. The connector according to claim 1, wherein
the accommodating chamber has a tube shape having the opening portion at a tube end portion;
the packing further includes a tubular projecting portion having a tubular diameter larger than that of the tube end portion and projecting so as to surround the lid-shaped portion; and
when the cover is at the closed position, the tubular projecting portion is configured to be displaced so as to approach an outer peripheral face of the tube end portion as the lid-shaped portion is displaced.

4. The connector according to claim 1, wherein
the support portion of the packing has a tube shape extending from the lid-shaped portion toward the cover, and has a bent shape narrowing in a direction in which a tubular diameter decreases after widening in a direction in which the tubular diameter increases as being separated from the lid-shaped portion.

5. The connector according to claim 1, wherein
the support portion of the packing includes a small-diameter portion having a tube shape extending from the lid-shaped portion toward the cover and connected to the lid-shaped portion, a large-diameter portion located at a position farther from the lid-shaped portion than the small-diameter portion and having a larger tubular diameter than the small-diameter portion, and a connecting portion connecting the small-diameter portion to the large-diameter portion.

6. The connector according to claim 1, wherein
the support portion of the packing has a tube shape extending from the lid-shaped portion toward the cover, and has a bellows shape in which increase and decrease of a tubular diameter are continuous as the support portion is separated from the lid-shaped portion.

7. The connector according to claim 1, wherein
the support portion of the packing has a tube shape extending from the lid-shaped portion toward the cover, and an opening end of the support portion is held by the cover so as to be covered with the cover.
